(19) United States
(12) Patent Application Publication
(10) Pub. No.: US 2006/0054611 A1
(43) Pub. Date: Mar. 16, 2006

(54) Fusion welded lap penetration joint

(76) Inventors: Israel Stol, Pittsburgh, PA (US); Kyle L. Williams, Shelocta, PA (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(21) Appl. No.: 10/938,025

(22) Filed: Sep. 10, 2004

(51) Int. Cl. B23K 9/00

(52) U.S. Cl. 219/137 R; 403/270; 219/121.46; 219/121.64

(57) ABSTRACT

A technique is taught for making a lap penetration weldment including a weld bead joining a first component to a second component, the first component overlying the second component, the weld bead penetrating through the first component and into the second component, the first component including a short overlapping portion between a centerline of the weld bead and an edge of the first component. Prior to forming the weld bead, the method includes applying to the short overlapping portion of the first component at least one normal force directed toward the second component, and applying to the short overlapping portion at least one tangential force directed toward the weld bead, the tangential force(s) preventing formation of cracks along a boundary of the weld bead, a fusion zone of the weld bead, or a heat affected zone of the weldment.

### CROSS REFERENCE TO RELATED APPLICATIONS

This application is closely related to copending U.S. Patent Application Gas Metal Buried Arc Welding of Lap-Penetration Joints, Ser. No. 10/438,675, filed on May 15, 2003, the teachings of which are fully incorporated by reference herein.

### FIELD OF THE INVENTION

The present invention relates to fusion welding of lap joints and, more particularly, it relates to fusion welded lap penetration joints having reduced discontinuities.

### BACKGROUND OF THE INVENTION

It is known to make fusion welded lap penetration joints in metal plates or sheets by means of several processes. These include gas metal buried arc welding (GMBA), laser beam, laser/gas metal arc, and plasma arc.

FIG. 1 illustrates a prior art lap penetration joint 10 made by one of the fusion welding processes cited above. A first component 12 having thickness 13 overlies a second component 14 having thickness 15. A fusion weld bead 16, penetrating through the first component 12 and into second component 14 joins component 12 to component 14. A short overlapping portion of component 12 is denoted 18. The edge of the short overlapping portion 18 is denoted 20 and the centerline of the fusion weld bead 16 is denoted 17. It has been found that a critical minimum applies to the edge distance 22 between the edge 20 of the short overlapping portion 18 and the centerline 17 of weld bead 16. If the edge distance 22 is less than the critical minimum, discontinuities tend to form in or close to the weld bead 16. This minimum is referred to in the art as the critical edge distance. The critical edge distance depends on the alloy compositions and on the thicknesses of the components being welded. For 1.5 mm 6061-T6 aluminum alloy being welded to 3 mm 6061-T6 aluminum alloy, the critical edge distance is about 32 mm (1.25″).

It is often the case that a lap penetration joint is required at a location close to an edge of the sheet or plate being joined. FIG. 2 shows a defective weldment 31 often resulting from prior art practices. In FIG. 2, a first component 32 having a short overlapping portion 34 overlies a second component 14. The thickness of first component 32 is denoted 13 and the thickness of the second component 14 is denoted 15. The distance 38 between the edge 36 of short overlapping portion 34 of first component 32 and the centerline 17 of the weld bead 16 is less than the critical edge distance.

FIG. 2 shows a discontinuity 26 in the weld bead 16, but close to its boundary, and another discontinuity 27 at the boundary of the weld bead 16. Discontinuities such as 26 and 27 tend to form at the intersection 23 of the interface 29 between the overlapping portion 34 of first component 32 and the second component 14 and the boundary of the weld bead 16. Although less common, discontinuities (not shown) may also form in the heat affected zone 25, usually in the first component 32.

These weld discontinuities are caused by a combination of the following factors. One factor is due to the fact that heat tends to be localized in the short overlapping portion 34 because heat cannot be sufficiently conducted away from the weld site. This is in contrast to the short overlapping portion 18 shown in FIG. 1, which has an edge distance 22 equal to or exceeding the critical edge distance, and for which heat is sufficiently conducted away. The short-overlapping portion 34 rises to a higher temperature and remains at the higher temperature for a longer time than the short overlapping portion 18 shown in FIG. 1.

Also, due to its lesser width, the short overlapping portion 34 is more flexible and compliant and is more subject to distortion than the cooler short overlapping portion 18. Upon solidification of the weld bead 16, the short overlapping portion 34 moves and distorts more than the short overlapping portion 18, which has an edge distance exceeding the critical edge distance. As the short overlapping portion 34 distorts, generally by bending away from the underlying second component 14, it introduces intense stresses between the overlapping parts, 34 and 14, and the adjoining weld bead 16. This stress, in combination with the stress-intensifying interfacial junction 23, leads to the formation of these discontinuities, which develop by tearing softened, and/or partly solidified weld metal.

In order to avoid these problems, it is conventional practice to avoid designs in which the component which is penetrated by a weld bead such as weld bead 16 would have an overlapping portion which is shorter than the critical edge distance for the alloys and thickness of the components being joined. The requirement that the overlapping portion have a certain minimum dimension generally adds weight to the final product produced by the welding process because the overlapping portion typically has no mechanical function except to prevent discontinuities during welding. Such unnecessary weight is particularly undesirable for automobiles, trucks, and aerospace applications and marine products. Also, the unnecessary metal adds to the cost of the product.

There is, therefore, clearly a need for a method of making welded lap penetration joints wherein the overlapping portions have smaller dimensions than the critical edge distances used currently.

### SUMMARY OF THE INVENTION

In one aspect, the present invention is a weldment including a first component and a second component, the second component disposed in overlapping relationship with the first component. A fused weld bead joins the first component to the second component, the fused weld bead penetrating through the first component and into the second component. The first component has a short overlapping portion whereby an edge to centerline distance from an edge of the first component to the centerline of the weld bead is less than a critical edge to centerline distance, the critical edge to centerline distance being a distance below which cracking tends to occur near and/or along a boundary of the weld bead, a fusion zone of the bead, or a heat affected zone of the weldment. The weldment is essentially free of discontinuities.

In another aspect, the present invention is a method of making a lap penetration joint, the lap penetration joint including a weld bead attaching a first component to a second component, the weld bead penetrating through the first component and into the second component, the first component having a short overlapping portion between a centerline of the weld bead and an edge of the first component. The method includes applying to the short overlapping portion of the first component at least one normal force directed toward the second component. The method also includes applying to the short overlapping portion of the first component at least one tangential force, the tangential force(s) being tangential (i.e parallel) to faying surfaces of the first component and the second components, the tangential force(s) being directed toward the weld bead, the tangential force(s) conteracting and preventing formation of cracks along a boundary of the weld bead, a fusion zone of the weld bead, or a heat affected zone of the weldment when the weld bead is made.

In an additional aspect, the present invention is a weldment including a first component and a second component, the second component disposed in overlapping relationship with the first component. A fused weld bead joins the first component to the second component, the fused weld bead penetrating through the first component and into the second component. The first component includes a short overlapping portion whereby an edge to centerline distance from a first edge of the first component to a centerline of the weld bead is less than a critical edge to centerline distance for the first component, the critical edge to centerline distance for the first component being a distance below which cracking tends to occur close to and/or along a boundary of the weld bead, a fusion zone of the bead, or a heat affected zone of the weldment; the second component also including a short overlapping portion whereby an edge to centerline distance from a second edge of the second component to a centerline of the weld bead is less than a critical edge to centerline distance for the second component. The critical edge to centerline distance for the second component is a distance below which cracking tends to occur close to and/or along the boundary of the weld bead, the fusion zone of the bead, or the heat affected zone of the weldment. The weldment is essentially free of discontinuities.

In yet another aspect, the present invention is a method of making a lap penetration joint, the lap penetration joint comprising a weld bead attaching a first component to a second component, the weld bead penetrating through the first component and into the second component. The first component includes a short overlapping portion between a centerline of the weld bead and a first edge of the first component, the second component also including a short overlapping portion between the centerline of the weld bead and a second edge of the second component. The method includes applying to the short overlapping portion of the first component at least one first normal force, the at least one first normal force being directed toward the second component, and applying to the short overlapping portion of the first component at least one first tangential force, the at least one first tangential force being tangential to faying surfaces of the first component and the second component, the at least one first tangential force being directed toward the weld bead. The method also includes applying to the short overlapping portion of the second component at least one second normal force, the at least one second normal force being directed toward the first component, and it includes applying to the short overlapping portion of the second component at least one second tangential force, the at least one second tangential force being tangential to faying surfaces of the first component and the second component, the at least one second tangential force being directed toward the weld bead. The method further includes forming the weld bead; the tangential forces counteracting and preventing formation of cracks close to and/or along a boundary of the weld bead, a fusion zone of the weld bead, or a heat affected zone of the weldment.

### BRIEF DESCRIPTION OF THE DRAWINGS

FIG. 1 is a schematic of a prior art fusion welded lap penetration joint having an overlapping portion with an edge distance equal to or exceeding the critical edge distance;

FIG. 2 is a schematic of a prior art attempt to make a fusion penetration lap weld with an overlapping portion having an edge distance less than the critical edge distance;

FIG. 3 is an illustration of a setup for making a fusion welded lap joint, the setup applying normal and tangential constraints to a short overlapping portion of the joint to prevent weld discontinuities;

FIG. 4 is an illustration of a setup for making a fusion welded lap joint, the setup applying one tangential constraint and two normal constraints to a short overlapping portion of the joint to prevent weld discontinuities;

FIG. 5 is an illustration of a setup for making a fusion welded lap joint, the setup employing a single clamp member to provide both normal and tangential constraints;

FIG. 6 is an illustration of a setup for making a fusion welded lap joint, the setup applying a tangential constraint and also applying normal constraints on both sides of the weld bead;

FIG. 7 is an illustration of a fusion welded lap penetration joint according to the present invention, the joint having an overlapping portion with an edge distance less than the critical edge distance;

FIG. 8 is a schematic illustration showing the path that stress follows from the first component through weld bead 16 to the second component when tension is applied to the weldment;

FIG. 9 illustrates a setup for making a fusion welded lap joint wherein both the first component and the second component have short overlapping portions, the short overlapping portions lying on opposite sides of the weld bead; and

FIG. 10 illustrates a setup for making a fusion welded lap joint wherein both the first component and the second component have short overlapping portions, the short overlapping portions lying on the same side of the weld bead.

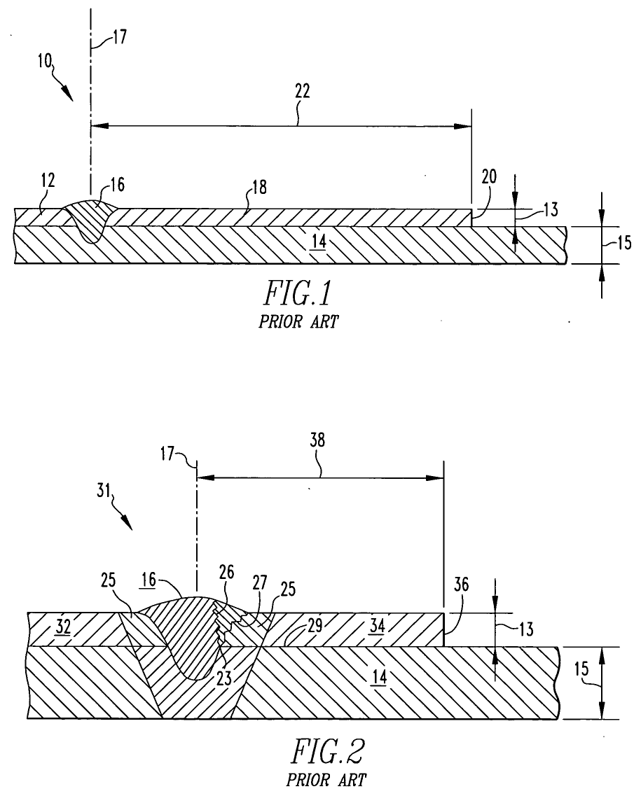

### DETAILED DESCRIPTION OF PREFERRED EMBODIMENTS

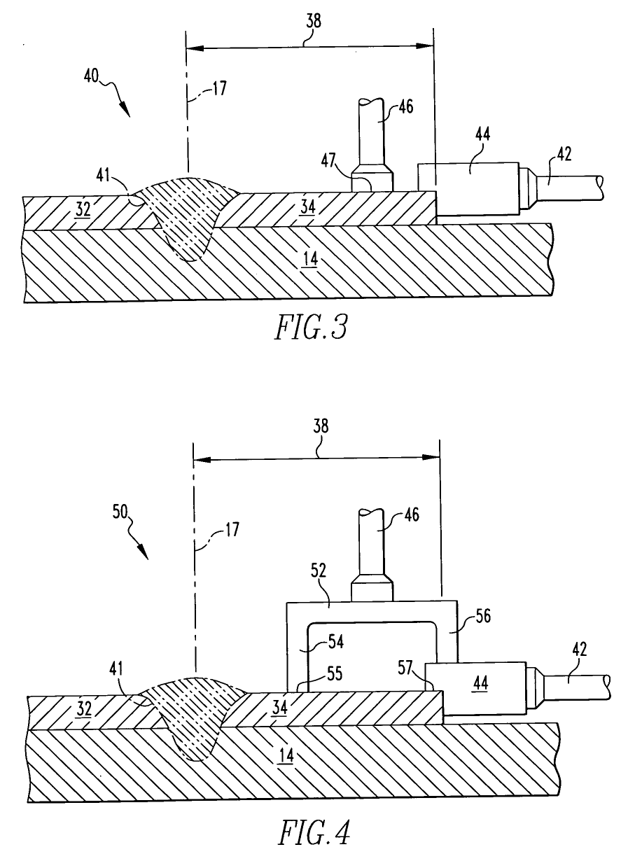

Referring now to FIG. 3, a setup 40 is shown, in accordance with the present invention. A first component 32 having a short overlapping portion 34 is placed over a second component 14. The intended site for a weld bead is indicated in phantom as 41. The edge to weld centerline distance 38 of the short overlapping portion 34 is less than the critical minimum distance for the first component 32 and the second component 14.

In accordance with the present invention, a clamp member 42 is positioned to exert a tangential force through pad 44 on the short overlapping portion 34. A normal force is also applied by the clamp member 46 to location 47 on the short overlapping portion 34. The clamp member 42 and the clamp member 46 may be portions of screw type clamps, hydraulic clamps, pneumatic clamps, electrically actuated clamps, or any other suitable type of clamps.

When the invention is practiced, according to this embodiment, the clamp member 42, the pad 44 and the clamp member 46 are placed in the positions indicated, and the tangential and normal forces are applied. A fusion penetration lap weld is then made at site 41. After the weld bead has solidified and cooled, the clamps 42 and 46 as well as the pad 44 are removed.

FIG. 4 illustrates an alternative setup 50, in accordance with another aspect of the invention. As before, a tangential force is applied by clamp member 42 through pad 44 to the short overlapping portion 34. Also, the clamp member 46 applies a normal force to the proportionalizing member 52 having first leg 54 and second leg 56. The first leg 54 applies a first normal force to short overlapping portion 34 at proximal site 55 and second leg 56 applies a second normal force to the distal site 57 on short overlapping portion 34 through pad 44. Because of the proportionalizing member 52, the normal force exerted by first leg 54 is proportional to the normal force exerted by the second leg 56.

When the invention is practiced, according to this embodiment, the clamp member 42 and the pad 44 are placed in position and the tangential force is applied to short overlapping portion 34. Also, the proportionalizing member 52 is placed in position and clamp member 46 is placed in position and caused to apply a normal force to proportionalizing member 52, thus applying proportional normal forces at proximal site 55 and at distal site 57 on the short overlapping portion 34. A fusion lap penetration weld is then made at site 41. After the weld bead has solidified and cooled, the clamps 42 and 46 as well as the proportionalizing member 52 and the pad 44 are removed.

FIG. 5 illustrates another alternative setup 60, in accordance with another aspect of the invention. In this setup, a clamp member 64 engages a notched pad 62 to exert a tangential force at pressure application site 65 on the end of short overlapping portion 34. Also, clamp member 64 exerts a normal force at pressure application site 57 on short overlapping portion 34.

When the invention is practiced, according to this embodiment, the clamp member 64 and the pad 62 are placed in position, and the tangential and normal forces are applied. A fusion lap penetration weld is then made at site 41. After the weld bead has solidified and cooled, the clamp 64 and the pad 62 are removed.

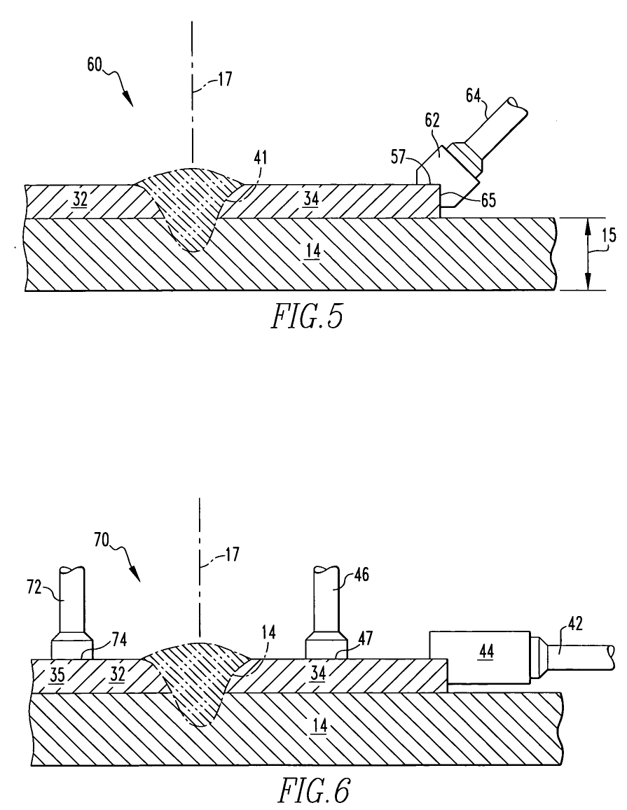

FIG. 6 illustrates a setup 70 in which a tangential force is applied to short overlapping portion 34 by clamp member 42 acting through pad 44. Also, in this configuration a normal force is applied by clamp member 46 at site 47 on the short overlapping portion 34 and, furthermore, at site 74, on the opposite side of the intended site 41 of the weld bead 16, clamp member 72 applies a normal force to the long overlapping portion 35 of first component 32.

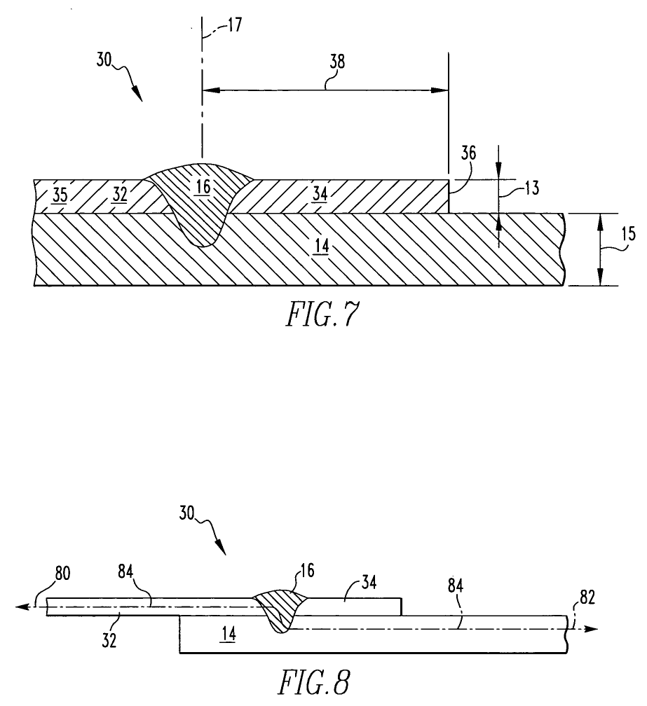

FIG. 7 illustrates a weldment 30 produced in accordance with the present invention. A first component 32 having a short overlapping portion 34 and a thickness 13 overlies a second component 14 having a thickness 15. First component 32 is joined to second component 14 by weld bead 16 which penetrates through first component 32 and into second component 14. The edge distance 38 between the edge 36 of short overlapping portion 34 and the centerline 17 of weld bead 16 is less than the critical edge distance. The weldment 30 is substantially free of discontinuities.

FIG. 8 shows why it is desirable for the short overlapping portion 34 to be as short as possible. FIG. 8 shows a tensile force 80 applied to first component 32 and an equal and opposite force 82 applied to the second component 14. These forces result in tension and tension/shear stresses in the weldment which generally follow path 84 from first component 32 through weld bead 16 and through second component 14. The short overlapping portion 34 is generally not involved in these stresses. To minimize the weight of the weldment 30, the short overlapping portion 34 should be as short as possible.

A weldment such as weldment 30 is preferred for applications wherein flange width and/or weight is critical. These applications include components of automobiles, trucks, trailers, railway vehicles, aerospace or marine products.

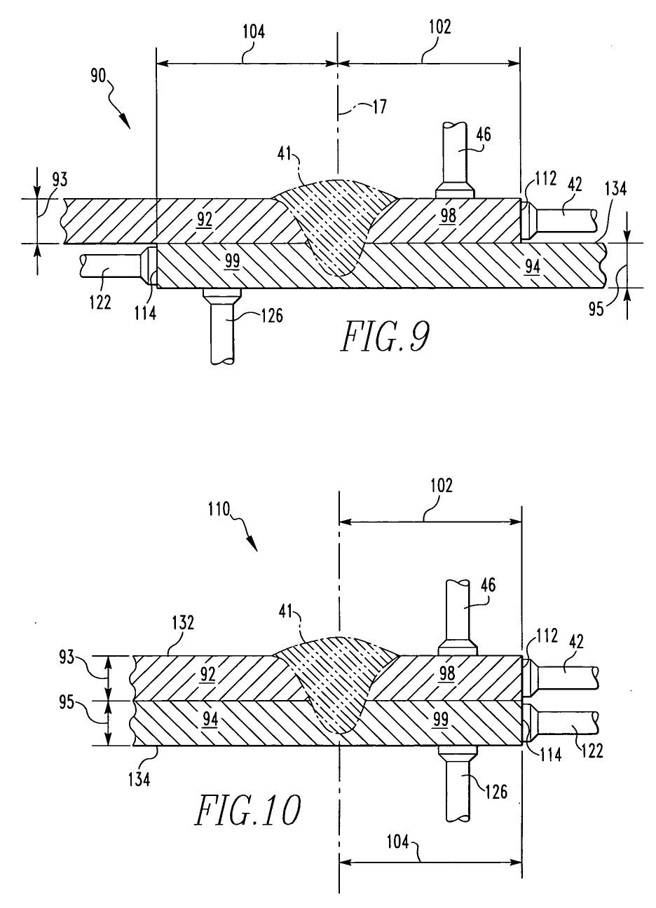

FIG. 9 illustrates a setup 90 for making a fusion welded lap joint wherein both the first component 92 and the second component 94 have short overlapping portions, which lie on opposite sides of the weld bead. First component 92 has thickness 93 and short overlapping portion 98. Short overlapping portion 98 has an edge to centerline distance 102 from edge 112 of first component 92 to centerline 17. Edge to centerline distance 102 is smaller than the critical edge to centerline distance for first component 92.

Second component 94 has thickness 95 and short overlapping portion 99. Short overlapping portion 99 has an edge to centerline distance 104 from edge 114 of second component 94 to centerline 17. Edge to centerline distance 104 is smaller than the critical edge to centerline distance for second component 94.

Preferably, remote portion 132 of first component 92 is immobilized, and remote portion 134 of second component 94 is immobilized, by means not shown. Clamp member 46 applies a first normal force to short overlapping portion 98 of first component 92 and, in accordance with the present invention, clamp member 42 applies a first tangential force to short overlapping portion 98 of first component 92. Likewise, clamp member 126 applies a second normal force to short overlapping portion 99 of second component 94 and, in accordance with the present invention, clamp member 122 applies a second tangential force to short overlapping portion 99 of second component 94

FIG. 10 illustrates a setup 10 for making a fusion welded lap joint wherein both the first component 92 and the second component 94 have short overlapping portions, which lie on the same side of the weld bead. First component 92 has thickness 93 and short overlapping portion 98. Short overlapping portion 98 has an edge to centerline distance 102 from edge 112 of first component 92 to centerline 17. Edge to centerline distance 102 is smaller than the critical edge to centerline distance for first component 92.

Second component 94 has thickness 95 and short overlapping portion 99. Short overlapping portion 99 has an edge to centerline distance 104 from edge 114 of second component 94 to centerline 17. Edge to centerline distance 102 is smaller than the critical edge to centerline distance for second component 94.

Preferably, remote portion 132 of first component 92 is immobilized, and remote portion 134 of second component 94 is immobilized, by means not shown. Clamp member 46 applies a first normal force to short overlapping portion 98 of first component 92 and, in accordance with the present invention, clamp member 42 applies a first tangential force to short overlapping portion 98 of first component 92. Likewise, clamp member 126 applies a second normal force to short overlapping portion 99 of second component 94 and, in accordance with the present invention, clamp member 122 applies a second tangential force to short overlapping portion 99 of second component 94.

After the setup shown in FIG. 9 or FIG. 10 is made, a weld bead 16 (not shown in these figures) is formed at the intended site 41 of weld bead 16.

As a specific example of this invention, a sheet of 6061-T6 aluminum 2 mm thick was welded to a sheet of 6061-T6 which was three millimeters thick. The 2 mm thick sheet was placed on top and it was this sheet which was penetrated by the gas metal buried arc welding process to yield a weld bead forming a lap penetration joint. The short overlapping portion of the 2 mm thick sheet had an edge distance less than the critical edge distance for this material.

The technique employed was gas metal buried arc welding. The filler wire was ER5356 and the filler wire diameter was 1.2 mm. The welding current was 307 Amperes and the welding voltage was 19.3 volts. The wire feed rate was 254 mm/sec and the welding speed of travel was 30 mm/sec.

This technique is recommended for welding components comprised of heat treatable and non-heat treatable alloys (e.g. 5xxx, 2xxx, 6xxx and cast A5xx aluminum alloys) in the form of extrusions, sheet, castings and/or forgings. For example, the first component may be a sheet, plate or casting, and the second component may be an extruded part, a sheet, plate or cast part. The first component may be a 5xxx aluminum sheet, and the second component may be a 6xxx extruded part.

The weld bead 16 may be made by gas metal arc welding, gas metal buried arc welding, laser beam welding, or hybrid laser/gas metal arc welding. It can also be made by plasma arc welding, or by laser/plasma hybrid welding.

By employing the techniques of this invention, it is often possible for the edge distance 38 to be as small as one third of the critical edge distance for the components being joined.

Although the presently preferred embodiments of the invention have been discussed in some detail above, it is to be understood that the invention may be otherwise embodied within the scope of the appended claims.

We claim:

1. A weldment comprising:
a first component;
a second component, said second component disposed in overlapping relationship with said first component;
a fused weld bead joining said first component to said second component, said fused weld bead penetrating through said first component and into said second component;
said first component including a short overlapping portion whereby an edge to centerline distance from an edge of said first component to a centerline of said weld bead is less than a critical edge to centerline distance, said critical edge to centerline distance being a distance below which cracking tends to occur close to and/or along a boundary of said weld bead, a fusion zone of said bead, or a heat affected zone of said weldment; and
said weldment being essentially free of discontinuities.

2. A weldment, according to claim 1, wherein said edge to centerline distance is less than about one third of said critical edge to centerline distance.

3. A weldment, according to claim 2, wherein said edge to centerline distance is about 5-10 mm and said critical edge to centerline distance is about 30 mm.

4. A weldment, according to claim 1, wherein said first component and/or said second component is/are comprised of 5xxx, 2xxx, and/or 6xxx aluminum alloy(s).

5. A weldment, according to claim 1, wherein a thickness of said first component and/or said second component is in a range from about 1 mm to about 5 mm.

6. A weldment, according to claim 1, wherein said weldment is a portion of an automobile, a truck, an aerospace product, or a marine product.

7. A weldment, according to claim 1, wherein said first component is a sheet, plate or cast part and said second component is an extruded part, sheet, plate, or cast part.

8. A weldment, according to claim 7, wherein said first component is a 5xxx aluminum sheet.

9. A weldment, according to claim 7, wherein said second component is a 6xxx extruded part.

10. A method of making a lap penetration joint, said lap penetration joint comprising a weld bead attaching a first component to a second component, said weld bead penetrating through said first component and into said second component, said first component including a short overlapping portion between a centerline of said weld bead and an edge of said first component, said method comprising:
applying to said short overlapping portion of said first component at least one normal force, said at least one normal force being directed toward said second component;
applying to said short overlapping portion of said first component at least one tangential force, said at least one tangential force being tangential to faying surfaces of said first component and said second component, said at least one tangential force being directed toward said weld bead, said at least one tangential force conteracting and preventing formation of cracks close to and/or along a boundary of said weld bead, a fusion zone of said weld bead, or a heat affected zone of said weldment; and
forming said weld bead.

11. A method, according to claim 10, wherein said step of forming said weld bead is performed by gas metal buried arc welding.

12. A method, according to claim 10, wherein said step of forming said weld bead is performed by laser beam welding.

13. A method, according to claim 10, wherein said step of forming said weld bead is performed by hybrid laser/gas metal arc welding.

14. A method, according to claim 10, wherein said step of forming said weld bead is performed by plasma arc welding.

15. A method, according to claim 10, wherein said step of forming said weld bead is performed by laser/plasma hybrid welding.

16. A method, according to claim 10, wherein said step of applying said at least one normal force is performed by at least one clamp member.

17. A method, according to claim 10, wherein said at least one normal force comprises a distal normal force and also a proximal normal force, said proximal normal force being applied closer to said weld bead than said distal normal force.

18. A method, according to claim 17, wherein said step of applying said proximal normal force is done by at least one clamp member.

19. A method, according to claim 17, wherein said step of applying said distal normal force is done by at least one clamp member.

20. A method, according to claim 17, wherein said distal normal force and said proximal normal force are applied by a single clamp member, said single clamp member engaging a proportionalizing member comprising a first pressure foot and a second pressure foot, said first pressure foot applying said distal normal force and said second pressure foot applying said proximal normal force.

21. A method, according to claim 20, wherein said distal normal force is communicated through a first pad, said at least one tangential force also being communicated to said short overlapping portion of said first component through said first pad.

22. A method, according to claim 10, further comprising a step of applying an additional normal force to said first component, said additional normal force being applied on a side of said weld bead opposite said short overlapping portion, on a long overlapping portion of said first component.

23. A method, according to claim 10, wherein said step of applying said at least one tangential force is performed by at least one clamp member.

24. A method, according to claim 10, wherein said at least one normal force and said at least one tangential force are applied by a single clamp member.

25. A method, according to claim 22, wherein said at least one normal force and said at least one tangential force are applied through a notched pad.

26. A weldment comprising:
a first component;
a second component, said second component disposed in overlapping relationship with said first component;
a fused weld bead joining said first component to said second component, said fused weld bead penetrating through said first component and into said second component;
said first component including a short overlapping portion whereby an edge to centerline distance from a first edge of said first component to a centerline of said weld bead is less than a critical edge to centerline distance for said first component, said critical edge to centerline distance for said first component being a distance below which cracking tends to occur close to and/or along a boundary of said weld bead, a fusion zone of said bead, or a heat affected zone of said weldment;
said second component including a short overlapping portion whereby an edge to centerline distance from a second edge of said second component to a centerline of said weld bead is less than a critical edge to centerline distance for said second component, said critical edge to centerline distance for said second component being a distance below which cracking tends to occur close to and/or along said boundary of said weld bead, said fusion zone of said bead, or said heat affected zone of said weldment; and
said weldment being essentially free of discontinuities.

27. A method of making a lap penetration joint, said lap penetration joint comprising a weld bead attaching a first component to a second component, said weld bead penetrating through said first component and into said second component, said first component including a short overlapping portion between a centerline of said weld bead and a first edge of said first component, said second component also including a short overlapping portion between said centerline of said weld bead and a second edge of said second component, said method comprising:
applying to said short overlapping portion of said first component at least one first normal force, said at least one first normal force being directed toward said second component;
applying to said short overlapping portion of said first component at least one first tangential force, said at least one first tangential force being tangential to faying surfaces of said first component and said second component, said at least one first tangential force being directed toward said weld bead;
applying to said short overlapping portion of said second component at least one second normal force, said at least one second normal force being directed toward said first component;
applying to said short overlapping portion of said second component at least one second tangential force, said at least one second tangential force being tangential to faying surfaces of said first component and said second component, said at least one second tangential force being directed toward said weld bead;
forming said weld bead; and
said tangential forces counteracting and preventing formation of cracks close to and/or along a boundary of said weld bead, a fusion zone of said weld bead, or a heat affected zone of said weldment.
